(19) United States
(12) Patent Application Publication
(10) Pub. No.: US 2009/0119619 A1
(43) Pub. Date: May 7, 2009

(54) METHOD, APPARATUS AND SOFTWARE FOR PROVIDING PATH USAGE DATA FOR LINKS BETWEEN DATA PAGES IN A COMPUTER SYSTEM

(76) Inventors: Thomas J. Bailey, Eastleigh (GB); Christopher D. Jenkins, Southampton (GB); Jonathan M. Roberts, Southampton (GB); Kieran P. Scott, Southampton (GB)

Correspondence Address: HOFFMAN WARNICK LLC, 75 STATE ST, 14 FL, ALBANY, NY, 12207, US

(21) Appl. No.: 12/212,893

(22) Filed: Sep. 18, 2008

(30) Foreign Application Priority Data
Nov. 2, 2007 (EP) 07119905.3

(51) Int. Cl. G06F 17/30; G06F 3/048

(52) U.S. Cl. 715/822; 707/100; 715/810; 707/E17.044

(57) ABSTRACT

A method, apparatus and software is disclosed in which links in web pages are provided with an indication of the most frequently used path from a given link. The most frequently used path is selectable by a user so as to enable the user to directly view the web page at the end of the path or at any point along that path.

### FIELD OF INVENTION

The present invention relates to a method, apparatus and software for providing path usage data for links between data pages in a computer system.

### BACKGROUND OF THE INVENTION

Computer systems commonly store data pages such as web pages and provide links between such data pages in the form of hyperlinks. Hyperlinks are arranged within a web page and when selected cause the linked page to be displayed. Links may be formed between pages on the same computer or other computers via a network such as a local area network (LAN) or a wide area network (WAN) such as the Internet.

Web browser application programs, commonly referred to as web browsers, are provided with a number of features to enable previously viewed or visited web pages to be identified by a user. For example, a history of visited pages may be collected as pages are browsed. A user can then return to a previously visited page by selecting it from the list of viewed pages provided by the history. Bookmarks, favorites and snapback are facilities provided by various browsers that enable a user to mark pages so that they appear in a named menu and can easily be returned to. In other words, such facilities provide the user with a shortcut back to a previously visited page. Thus a user is able to move quickly to a significant or commonly used page. However, one problem with such arrangements is that the selection of the pages for inclusion in such facilities has to be performed manually while the desired page is being viewed. In other words, the user has to make the selection decision based on projected future use of a given page. As a result, such facilities often contain significant numbers of page references that are not used. This can make the facility more difficult to use and may also require the facility to be maintained.

### SUMMARY OF THE INVENTION

An embodiment of the invention provides a method for providing path usage data for links between data pages in a computer system, the method comprising: recording link data representing a selection of links between data pages by a user; utilizing the link data to identify one or more previously used paths from a given link in a current data page; and in response to user indication of the given link, providing a representation of the previously used paths to the user.

A plurality of previously used paths may be identified and the most frequently used of paths identified and provided to the user. The previously used path may be calculated for each link in the current data page. The representation of the previously used path may be selectable by the user and in response to such user selection the data page at the end of the previously used path is requested for the user. The link data may be specific to a group of one or more users.

The link data may record the use of each link selected by a user by means of data identifying: the selected link; the current data page on which the selected link was located when selected; the previously viewed data page from which the user linked to the current data page; the destination page for the selected link; and a time stamp determining the time at which the selected link was selected by the user.

Each link in the current page that forms part of a respective previously used path may be provided with a specific visual indication. The visual indication for each the link on the current page may be arranged to provide an indication of the frequency of use of a path from each link relative to that of the other links on the current page. A plurality of most frequently used paths may be calculated for a given link and presented to the user in a selectable list. Only the link data for links selected within a predetermined time limit may be utilized for calculating the previously used paths. Each set of the link data may be weighted in dependence on its age when calculating the previously used paths. The data page may be a web page and the links are hyperlinks.

Another embodiment provides an apparatus for providing path usage data for links between data pages in a computer system, the apparatus comprising: a system for recording link data representing the selection of links between data pages by a user; utilizing the link data to identify one or more previously used paths from a given link in a current data page; and providing a representation of the previously used paths to the user, in response to user indication of the given link.

A further embodiment provides a group of one or more programs arranged to enable a group of one or more programmable devices to perform a method for providing path usage data for links between data pages in a computer system, the method comprising: recording link data representing the selection of links between data pages by a user; utilizing the link data to identify one or more previously used paths from a given link in a current data page; and in response to user indication of the given link, providing a representation of the previously used paths to the user.

Another embodiment provides a group of one or more programs arranged to enable a group of one or more programmable devices to provide an apparatus for providing path usage data for links between data pages in a computer system, the apparatus comprising: a system for recording link data representing the selection of links between data pages by a user; a system for utilizing the link data to identify one or more previously used paths from a given link in a current data page; and a system for providing a representation of the previously used paths to the user, in response to user indication of the given link.

### BRIEF DESCRIPTION OF THE DRAWINGS

Embodiments of the invention will now be described, by way of example only, with reference to the accompanying drawings.

FIG. 1 is a schematic illustration of a computer system providing web servers and a web browser client.

FIG. 2 is a schematic illustration of software providing the web browser client of FIG. 1.

FIG. 3 is a table illustrating data used by the web browser client of figure 2.

FIG. 4 is an illustration of a screen shot from the web browser client of FIG. 2.

FIGS. 5 and 6 are flow charts illustrating processing performed by the web browser client of FIG. 2.

### DETAILED DESCRIPTION OF THE INVENTION

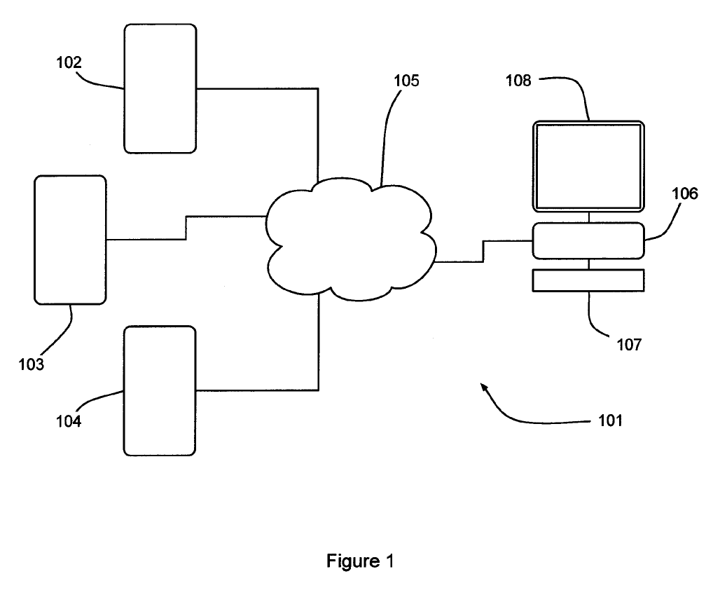

With reference to FIG. 1, a computer system 101 comprises three server computers 102, 103, 104 connected via a wide area network (WAN) 105 with a client computer 106. The client computer 106 comprises a keyboard 107 and a display 108. The server computers are arranged with web server application programs for storing and providing data pages in the form of web pages over the network 105 to the client computer 106. The web pages are provided in response to user requests input at the client computer via the keyboard 107 and displayed to the user via the display 108.

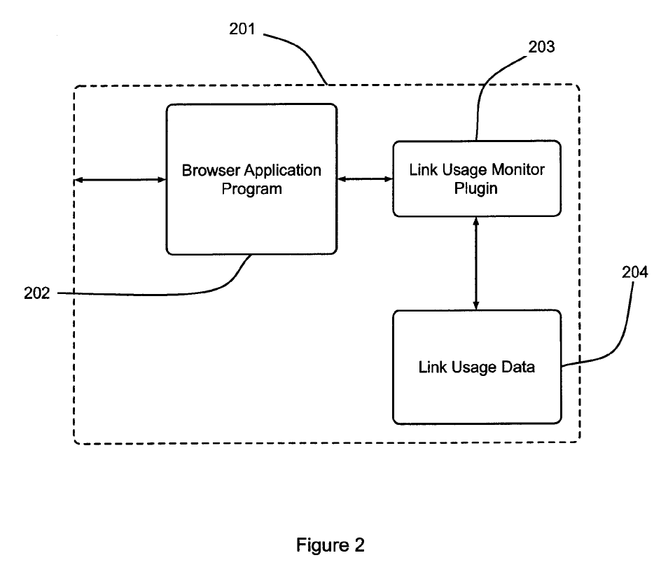

With reference to FIG. 2, the client computer 106 is loaded with an operating system 201 on which a web browser application program 202 is installed. The web browser 202 enables a user to request and view web pages, and to otherwise interact with the facilities provided by the web servers 102, 103, 104. The web browser 202 is provided with further functionality by way of a link usage monitor (LUM) plugin 203. The link usage monitor plugin 203 is arranged to monitor the links within web pages that are used by a user and to store data representing such use as link usage data 204.

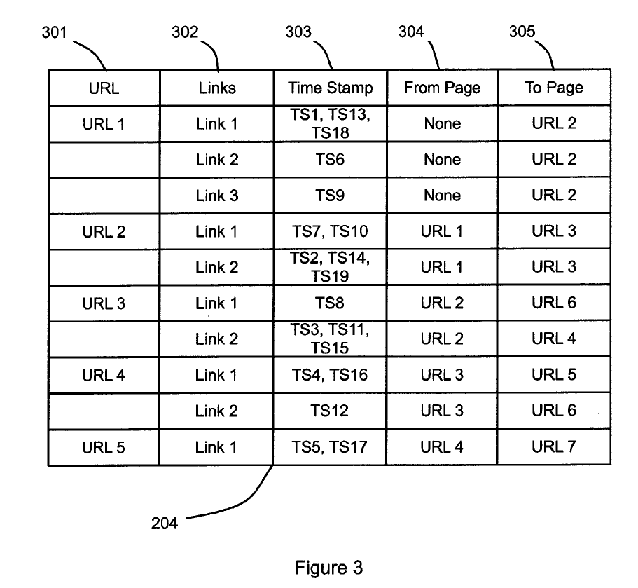

With reference to FIG. 3, the link usage data 204 comprises an entry for each link selected by a given user within a web page viewed via the web browser 202. Each entry comprises data representing an identification of the web page such as a network address in the form of a Universal Resource Locator (URL) 301, an identification of the selected link 302, a time stamp 303 indicating the time at which the link was selected, a URL for the previous page (From Page) 304 from which the user linked to the current page and a URL for the next page (To Page) 305 to which the user was linked via the selected link. In other words, the link usage data 204 provides a detailed history of the links used by the user.

In addition to collecting the link usage data 204, the (LUM) plugin 203 is further arranged to analyze the usage data 204 and identify paths of links traversed by the user from a given link in a currently displayed page. In other words, the (LUM) plugin 203 identifies where the user has visited a series of web pages, moving between each one via the links provided by each page, to reach a destination page. In the present embodiment, a given web page forms part of a path if loaded in the web browser 202 for up to a predetermined time period. If the web page is displayed for a time exceeding the time period then it is treated as the end of a current path. This display time period is determined from the difference between the time stamps 303 for respective pages. The linking between two pages is identified from the respective From Page and To Page entries 304, 305. In the present embodiment, the predetermined time limit is set to a default value of two seconds and is user modifiable. In addition to identifying paths traversed by the user from a given link, where a path has been traversed a number of times the (LUM) plugin 203 is further arranged to identify the most frequently used of those paths.

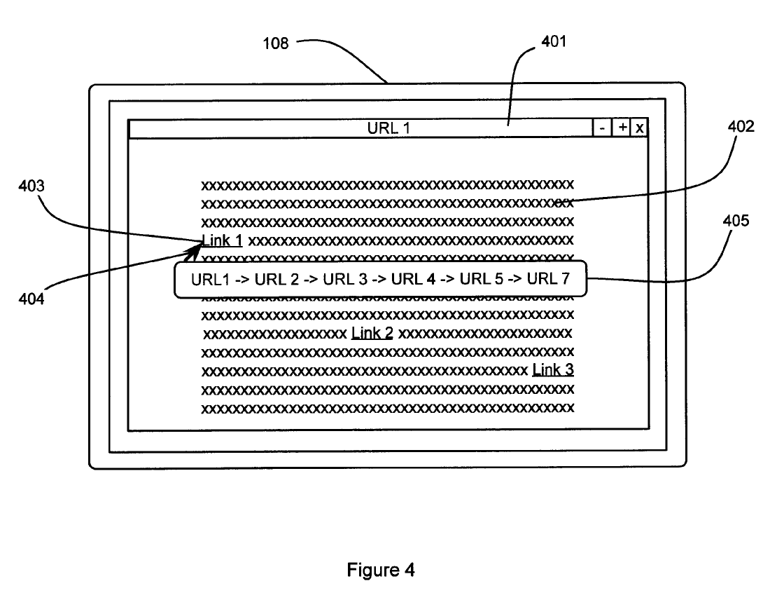

The (LUM) plugin 203 is arranged to calculate the most frequently used (MFU) path for each link in a given page in response to the page being loaded into the web browser 202. Subsequently, in response to a user indication of a given link in the form of hovering a pointer icon over the link, the (LUM) plugin 203 is arranged to display the MFU path to the user. The user is then able to select the displayed MFU path and jump straight to the end of the path and load the destination page into the web browser 202. FIG. 4, shows the display 108 displaying a web browser window 401. The web browser 202 has loaded and displays the data 402 of the web page URL 1 which comprises a number of links 403. In response to a user having hovered a pointer 404 over a link 403 (Link 1), the (LUM) plugin 203 displays a selectable MFU path 405 calculated from the link data 204. The displayed MFU path 405 links from the current page URL 1 to a destination page identified by URL 7. Referring to the link data 204 in the table of FIG. 3, it can be seen that two previously traversed paths emanate from the web page URL 1 via the link named Link 1. The first path has been traversed twice and ends at the web page URL 7 via the intervening pages of URL 2, URL 3, URL 4, and URL 5. The second path has been traversed only once and ends at web page URL 3. Thus the first path is the MFU path 405 and is displayed to the user for selection to provide the user with the facility to jump straight to the destination page URL 7 without needing to navigate the intervening pages URL 2, URL 3, URL 4, and URL 5.

In response to the selection of the MFU path 405, the (LUM) plugin 203 is arranged to update the link data 204 with dummy entries for each link in the selected MFU path so as to reflect the use of the MFU path in its constituent links or sub paths recorded in the link data 204. Each such dummy entry is provided with the same time stamp representing the selection time of the MFU path 405. Such dummy entries provide two functions, firstly updating the frequency of use of the MFU but also providing an indication that a provided MFU has been selected for that path by virtue of each link entry having the same time stamp.

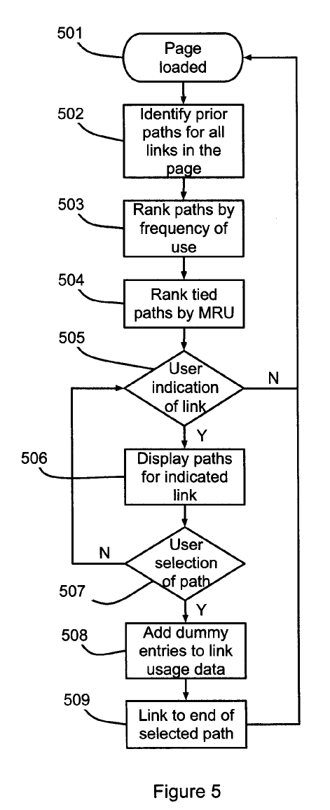

The processing performed by the (LUM) plugin 203 in response to user indication of a link will now be described in further detail with reference to the flow chart of FIG. 5. At step 501, in response to the loading of a web page by the web browser application program 202, this element of the processing of the (LUM) plugin 203 is initiated and processing moves to step 502. At step 502, the link usage data 204 is analyzed to identify all prior paths from each link in the loaded page. The links in the current loaded page are identified from the Document Object Model (DOM) for the page. Processing then moves to step 503 where, if more than one path is identified for a given link, the paths are ranked by frequency of use. Processing then moves to step 504 where, if more than one path for a given link has the same frequency of use, those paths are ranked by how recently the respective path was used. Processing then moves to step 505 where user indication of a link is awaited and if no user indication is received before a new page is requested for loading then processing returns to step 501 and proceeds as described above. If at step 505 a user indication is made for one of the links on the loaded page, processing moves to step 506 where the ranked list of MRU paths for the link is displayed to the user as a selectable list and processing moves to step 507 to await user selection of a displayed MRU path. If no selection is made then processing returns to step 505 and proceeds as described above. If at step 507 a selection is made then processing moves to step 508 where the dummy entries are added to the link usage data 204 for each link in the selected MRU path as described above and processing moves to step 509. At step 509 the destination page of the selected MRU path is requested for loading into the web browser 202 and processing returns to step 501 and proceeds as described above.

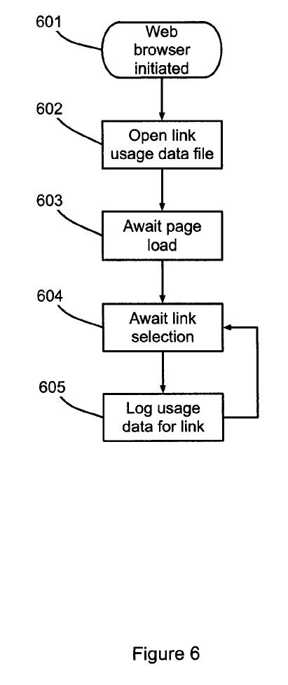

The processing performed by the (LUM) plugin 203 when recording link usage in the link usage data 204 will now be described in further detail with reference to the flow chart of FIG. 6. At step 601, in response to the launch of the web browser application program 202, this element of the processing of the (LUM) plugin 203 is initiated and processing moves to step 602. At step 602, any existing link usage data file 204 is located or, if none exists, a new link usage data file 204 is created. Processing then moves to step 603 where processing holds until a web page is loaded at which point processing moves to step 604. At step 604, once the page is loaded processing holds until a link is selected by the user. Once a link is selected, processing then moves to step 605. At step 605, entries in the usage data file 204 are made for the selected link as described above. Processing then returns to step 604 and continues as described above.

In another embodiment, the functions of the LUM plugin may be provided by a server in a network so as to enable link usage data to be compiled for a group of one or more users. The collection of link usage data may be performed by web server application programs and passed to a centralized link usage data server for subsequent provision to web browsers when loading pages or when links are indicated by users. In this embodiment, authentication data for users may be included for each entry in the link usage, that is, for each use of a link for a given user. In other words, every time a link is clicked or selected, authentication data for the user is recorded in the link usage data. The authentication data may comprise the user's username, role (administrator, user, guest) or group membership. This information may then be used when calculating the MRU path. For example, the MRU path may be calculated based on users from the same group or having the same role as a given user, to enable a user of a given group or role to follow the MRU path for that group or role.

In a further embodiment, older link usage data is treated with decreasing importance when calculating the MRU path. In another embodiment, link usage data is only maintained for a predetermined time before being deleted or discounted from calculations of MRU paths. In a further embodiment, only a predetermined amount of link usage data is maintained for each link. In a further embodiment, other factors such as time of day variations are taken into account when calculating the MRU path. In a further embodiment, each MRU path in the list presented to the user is provided with an indication of its frequency of use or any other data on which its calculation may have been based.

In another embodiment, the highlighting or other representation of the links within a page is varied in dependence on a relative measure of the frequency of use of the paths from each respective link. In other words, the links from which more frequently used paths emanate are represented differently from those links from which less frequently used paths emanate. The measure may be a frequency scale that correlates with particular representations or display formats for links.

In another embodiment, the sub paths of the presented MFU path presented to the user are selectable so as to enable the user to jump to any point along the MFU path. In a further embodiment, link data is not recorded for links traversed via a back button, manual entry of URLs or circular paths. In a further embodiment, only the single most recently used path calculated for a given link is displayed to the user for selection. In another embodiment, the MRU paths for a given link are calculated on the fly in response to the user indication of the link. In another embodiment, the LUM plugin is arranged to provide one or more paths from a given link without establishing any ranking such as frequency of use or how recently used.

In a further embodiment, the link usage data includes text that provides a meaningful description of a given link in each identified URL. This text may be the text from the link tag in the Hypertext Mark-up Language (HTML) document or the title of the target page. This descriptive text may be provided as the identification of each link in the MRU path presented to the user for selection.

It will be understood by those skilled in the art that the apparatus that embodies a part or all of the present invention may be a general purpose device having software arranged to provide a part or all of an embodiment of the invention. The device could be a single device or a group of devices and the software could be a single program or a set of programs. Furthermore, any or all of the software used to implement the invention can be communicated via any suitable transmission or storage means so that the software can be loaded onto one or more devices.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A method for providing path usage data for links between data pages in a computer system, the method comprising:
recording link data representing a selection of links between data pages by a user;
utilizing the link data to identify one or more previously used paths from a given link in a current data page; and
in response to user indication of the given link, providing a representation of the previously used paths to the user.

2. A method according to claim 1, wherein a plurality previously used paths are identified, and wherein the most frequently used paths are identified and provided to the user.

3. A method according to claim 1, wherein the previously used path is calculated for each link in the current data page.

4. A method according to claim 1, wherein the representation of the previously used path is selectable by the user and in response to such user selection the data page at an end of the previously used path is requested for the user.

5. A method according to claim 1, wherein the link data is specific to a group of one or more users.

6. A method according to claim 1, wherein the link data records a use of each link selected by a user by means of data identifying:
the selected link;
the current data page on which the selected link was located when selected;
a previously viewed data page from which the user linked to the current data page;
a destination page for the selected link; and
a time stamp determining a time at which the selected link was selected by the user.

7. A method according to claim 1, wherein each the link in the current page that forms part of a respective previously used path is provided with a specific visual indication.

8. A method according to claim 7, wherein the visual indication for each link on the current page is arranged to provide an indication of a frequency of use of a path from each link relative to that of the other links on the current page.

9. A method according to claim 2, wherein the plurality of most frequently used paths is calculated for a given link and presented to the user in a selectable list.

10. A method according to claim 1, wherein only the link data for links selected within a predetermined time limit is utilized for calculating the previously used paths.

11. A method according to claim 1, wherein the link data is weighted in dependence on its age when calculating the previously used paths.

12. A method according to claim 1, wherein the data page is a web page and the links are hyperlinks.

13. Apparatus for providing path usage data for links between data pages in a computer system, the apparatus comprising:
a system for recording link data representing a selection of links between data pages by a user;
a system for utilizing the link data to identify one or more previously used paths from a given link in a current data page; and
a system for providing a representation of the previously used paths to the user, in response to user indication of the given link.

14. Apparatus according to claim 13, wherein a plurality previously used paths are identified, and wherein the most frequently used paths are identified and provided to the user.

15. Apparatus according to claim 13, wherein the previously used path is calculated for each link in the current data page.

16. Apparatus according to claim 13, wherein the representation of the previously used path is selectable by the user and in response to such user selection the data page at the end of the previously used path is requested for the user.

17. Apparatus according to claim 13, wherein the link data is specific to a group of one or more users.

18. Apparatus according to claim 13, wherein the link data records the use of each link selected by a user by means of data identifying:
the selected link;
the current data page on which the selected link was located when selected;
a previously viewed data page from which the user linked to the current data page;
a destination page for the selected link; and
a time stamp determining the time at which the selected link was selected by the user.

19. Apparatus according to claim 13, wherein each link in the current page that forms part of a respective previously used path is provided with a specific visual indication.

20. Apparatus according to claim 19, wherein the visual indication for each the link on the current page is arranged to provide an indication of a frequency of use of a path from each link relative to that of the other links on the current page.

21. Apparatus according to claim 14, wherein a plurality of most frequently used paths is calculated for a given link and presented to the user in a selectable list.

22. Apparatus according to claim 13, wherein only the link data for links selected within a predetermined time limit is utilized for calculating the previously used paths.

23. Apparatus according to claim 13, wherein the link data is weighted in dependence on its age when calculating the previously used paths.

24. Apparatus according to claim 13, in which the data page is a web page and the links are hyperlinks.
